(19) United States
(12) Patent Application Publication
(10) Pub. No.: US 2021/0301799 A1
(43) Pub. Date: Sep. 30, 2021

(54) Leveraged Compressor

(71) Applicant: James Clements, Richmond, IN (US)

(72) Inventor: James Clements, Richmond, IN (US)

(21) Appl. No.: 16/828,853

(22) Filed: Mar. 24, 2020

(51) Int. Cl. F04B 9/04; F04B 39/08

(52) U.S. Cl. CPC F04B 9/042; F04B 17/03; F04B 39/08

(57) ABSTRACT

In accordance with one aspect of the present disclose, a fluid compressor for compressing a fluid is disclosed. The fluid compressor has a frame and a piston assembly. The piston assembly has a compression chamber connected to the frame, and the compression chamber includes a movable piston inside of the compression chamber along with a connection rod of a smaller transverse dimension than the diameter of the piston connected to the piston at a first end of the connection rod. The fluid compressor further has a pivot point located on the frame, and a lever connected to the pivot point. The lever has a short end and a long end on opposite sides of the pivot point, and the short end is connected to a second end of the connection rod. Further included is a lifting device for raising and lowering the lever.

### CROSS-REFERENCE TO RELATED APPLICATIONS

This application claims priority to U.S. Provisional Application No. 62/822,915 filed Mar. 24, 2019, which is incorporated by reference in its entirety.

### FIELD OF THE DISCLOSURE

This disclosure relates generally to fluid compressors, compressing systems and methods of compressing a fluid. More particularly, the present invention relates to a compressor having a cam and a lever.

### BACKGROUND

Even with modern technology and advancements in the accuracy of machining and efficient motors, using compressors to create compressed fluids is a very energy intensive process. Compressed air is often an expensive source of energy due to the low efficiency of traditional compressed air systems.

One common type of compressor is the reciprocating compressor. Reciprocating compressors are positive-displacement devices that generally utilize a crankshaft that is coupled to pistons, via connecting rods and crossheads, to reciprocally drive the pistons and compress a fluid within an attached cylinder. Reciprocating compressors typically include a frame that houses various internal components, such as the crankshaft. In one common type of reciprocating compressor, crosshead guides are coupled between compression cylinders and the frame and may cooperate with the crankshaft to induce linear motion of the crossheads.

However, the process of driving the pistons to compress a fluid within an attached cylinder is often very energy intensive due to the amount of force needed to compress the air. This often results in the need of powerful motors that are inefficient and increases the cost of energy needed to create a desired amount of compressed fluid.

Thus, a way to create voluminous amounts of compressed fluid utilizing a less energy demanding motor is desired

The disclosed system, method and fluid compressor is directed to overcoming one or more of the problems set forth above.

### SUMMARY

The disclosure presented herein relates to a fluid compressor, compressing system and method of compressing a fluid. More specifically, fluid compressor, fluid compressor system or method of compressing fluid using concept of leverage to reduce the amount of energy needed to compress a fluid. The fluid compressor, in one non-limiting embodiment, has a frame with one or more piston assemblies attached. The frame has one or more pivot points and one or more levers having a short end and a long end. In this embodiment, a motor rotates a cam, and the cam pushes the one or more levers up and down. The short end of the one or more levers is each attached to a connection rod that pushes up a piston inside of the compression chamber to compress the fluid.

In some embodiments, the preceding and following embodiments and descriptions are for illustrative purposes only and are not intended to limit the scope of this disclosure. Other aspects and advantages of this disclosure will become apparent from the following detailed description.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The preceding and following embodiments and descriptions are for illustrative purposes only and are not intended to limit the scope of this disclosure. Other aspects and advantages of this disclosure will become apparent from the following detailed description.

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 depicts a perspective view of an exemplary fluid compressor according to various aspects of the present disclosure.

FIG. 2 is a top view of the fluid compressor of FIG. 1.

FIG. 3 is a front view of Section AA of the fluid compressor shown in FIG. 2

FIG. 4 is a perspective view of the fluid compressor of FIG. 1.

FIG. 5 depicts a perspective view of an exemplary fluid compressor according to various aspects of the present disclosure.

FIG. 6 is a front view of the fluid compressor shown in FIG. 5.

FIG. 7 is a top view of the fluid compressor shown in FIG. 5.

FIG. 8 is a front view of Section AA of the fluid compressor shown in FIG. 7.

FIG. 9 is a rear perspective view of the fluid compressor shown in Fig.

### DETAILED DISCRETION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description includes one or more embodiments for various fluid compressors that may be used to provide a fluid compressor that utilizes the concept of leverage to provide a fluid compressor that requires less energy to compress fluid. Additionally, the fluid compressor may be used to compress air with a smaller motor that what a traditional air compressor would require to compress a similar amount of air. In one or more embodiments, a method of compressing fluid utilizing a cam and a lever to may be provided. For example, in one or more embodiments, various cams, levers and pistons can be utilized in a method to of compressing fluid. Elements included herein are meant to be illustrative, rather than restrictive. Persons having ordinary skill in the art relevant to the present disclosure may understand there to be equivalent elements that may be substituted with the present disclosure without changing the essential function or operation of the fluid compressor.

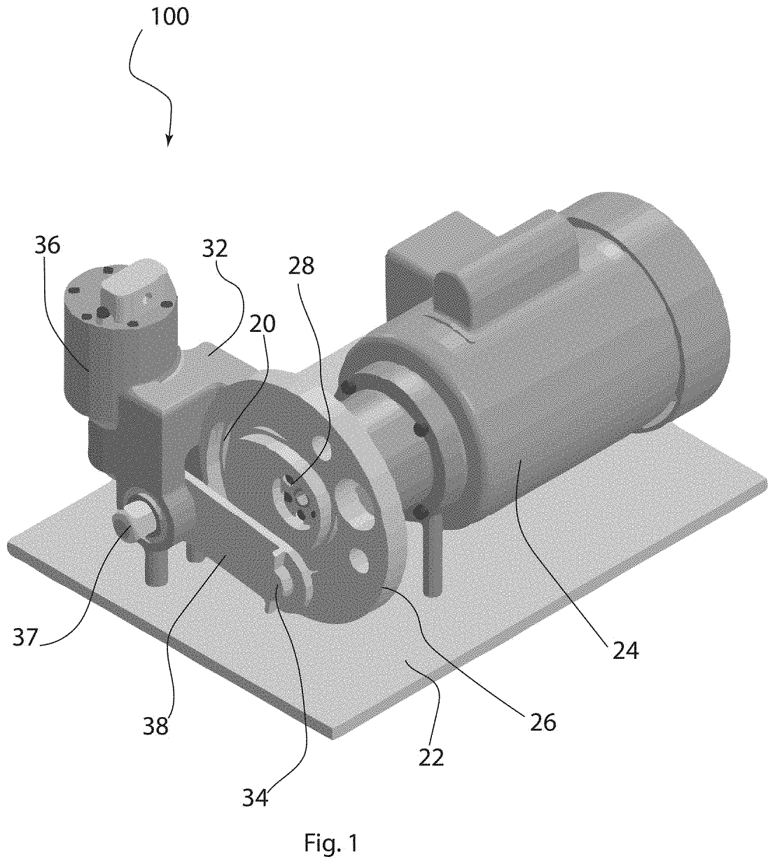

It is noted that any of the fluid compressors shown in FIGS. 1-9 may be formed from any suitable material, even if the cross-hatching used in any of these Figures may be illustrative of a material.

FIG. 1 depicts a perspective view of an exemplary fluid compressor 100 according to various aspects of the present disclosure. FIG. 1 shows the base 22, the motor 24, the cam 26, the lever 38, the frame 32, the piston assembly 36, the pivot point 37, the cam follower groove 20, the motor coupling bearing assembly 28, and the attachment point 34.

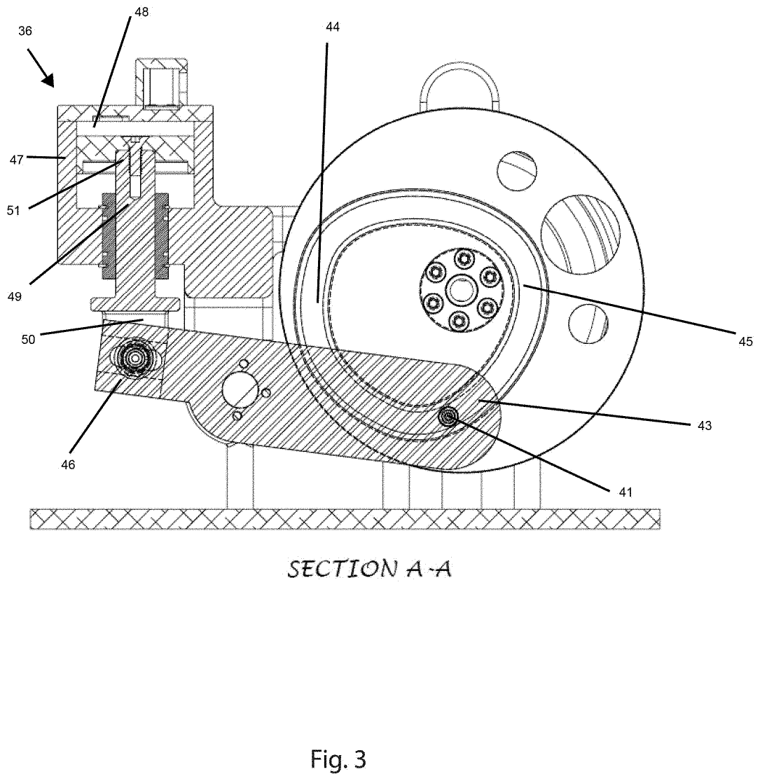

In the FIG. 1 embodiment, the motor 24 is connected to the cam 26 at the motor coupling bearing assembly 28. The motor can be an electric motor or any motor capable of rotating the cam, or moving the lever 38 up and down. As the cam 26 is rotated by the motor 24, the lever 38, attached to a cam follower 41 at the attachment point 34, pivots along the pivot point 37. In this embodiment, as the cam 26 is rotated, the cam follower 41, best shown in FIG. 3, is movably coupled to, and moves along, a cam follower groove 20 causing a first end 43 of the lever 38 to raise as the cam follower 41 travels towards a nadir 45 of the cam follower groove 20, and causing the first end 43 of the lever 38 to lower as the cam follower 41 travels towards an apex 44 of the cam follower groove 20. Further, in this embodiment, a second end 46 of the lever 38 is raised when as the cam follower 41 approaches the apex 44, and lowered when the cam follower 41 approaches the nadir 44. As the cam follower follows the cam follower groove 20 as the cam 26 rotates, the lever 38 will be moved up and down. In a further embodiment, the first and second ends 44, 46 of the lever may raise or lower inversely along the pivot point 37 differently depending on the shape of the shape of the cam follower groove 20 relative to the shape of the cam 26, and attachment point of the cam 26 to the motor 24.

The lever 38 is connected to the frame 32 at the pivot point 37. The lever 38 has a long end on the one side of the pivot point 37 proximal the first end 43, and short side on the other side of the pivot point 37 proximal the second end 46. The long end of the lever 38 is connected to the cam follower 41 in the FIG. 1 embodiment, but in other embodiments it is the short end.

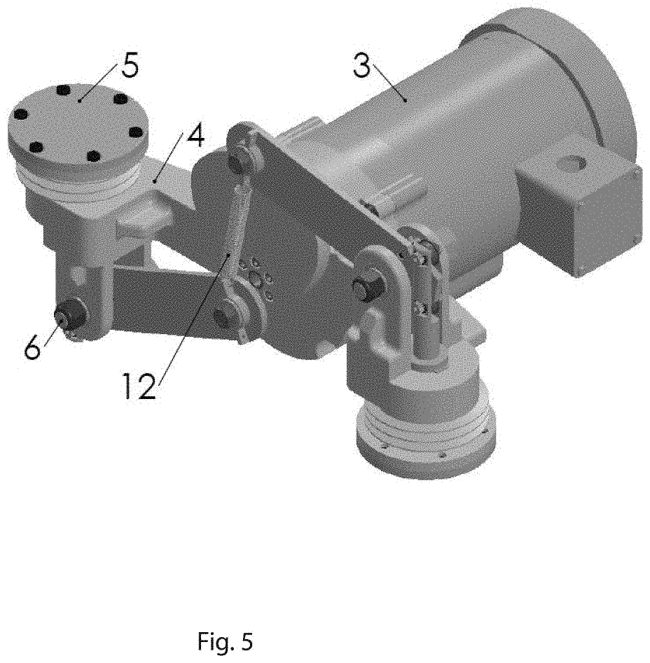

In the FIG. 1 embodiment, the cam 26 is cylindrical shaped disk that has the cam follower groove 20 that has been carved, or cut some other way, into it. In another embodiment the cam 26 is a traditional cam, such as the cam in the FIG. 5 embodiment. In a further embodiment, the fluid compressor 100 does not have a cam, but has another method of moving the long end of the lever 38 up and down. In a further embodiment, and method of moving the lever 38 up and down can be used.

As best shown in FIG. 3, connected to the frame 32 is the piston assembly 36. The piston assembly 36 is comprised of a compression chamber 47 connected to the frame having a movable piston 48 inside of the compression chamber and a connection rod 49 of a smaller transverse dimension than the diameter of the piston and is connected to the piston at a first end 50 of the connection rod 49. At a second end 51 of the connection rod 49, the connection rod 49 is connected to the short end of the lever 38 at the second end 46. The piston assembly 36, in one embodiment, also can include valves to insert uncompressed air and let the compressed air out.

In one embodiment, when the cam 26 rotates and raised and lowers the first end 43 of the lever 38, the second end 46 of the lever 38 inversely to the first end 43. The first end 43 of the lever moving in an inverse relationship to the second end 46 creates leverage, and this leverage is used to move the connection rod 49 up and down to compress air with the piston inside of the piston assembly 36 compression chamber 47. The use of leverage means the motor 24 does not have to use as much energy to compress air, as the fluid compressor 100 is utilizing the concept of leverage to compress air in the piston assembly 36.

The cam, in another embodiment, the lifting device may not be the cam 26, but may be another lifting device. The use of the cam 26 as the lifting device on the first end 43 of the lever 38 is shown, but in further embodiments, there are numerous ways to actuate the lever. For example liner cam, reversing ball screw etc. may all be used as the lifting device. In further embodiments, any of these methods of actuating the lever can be used.

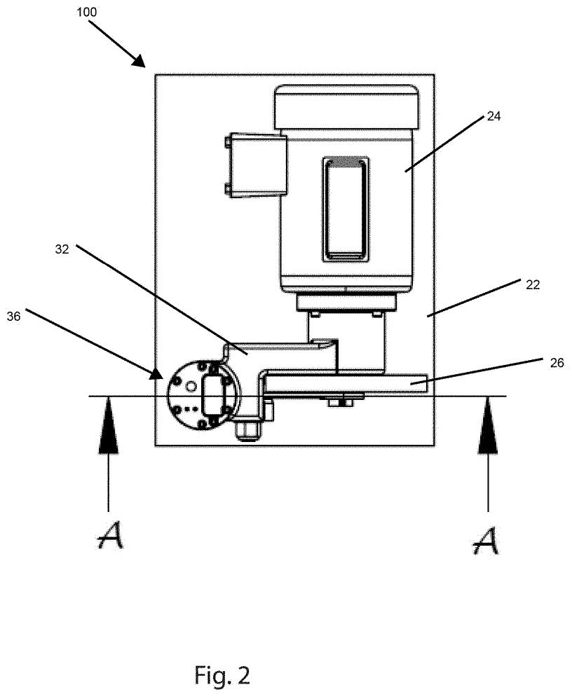

FIG. 2 is a top view of the fluid compressor of FIG. 1. This figure shows the base 22, the cam 26, the frame 21, and the piston assembly 36.

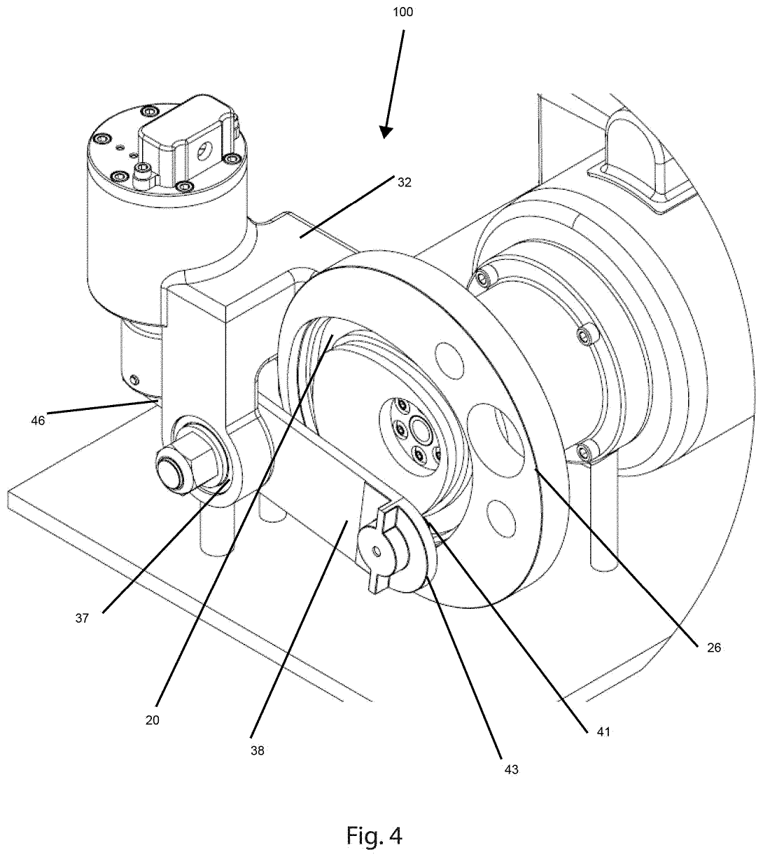

FIG. 4 is a perspective view of the fluid compressor of FIG. 1. This view the cam follower groove 20, and how the cam follower 41 moves along and is movably coupled to the cam follower groove 20 as the cam 26 is rotated. As the cam follower 41 follows the cam follower groove 20, the first end 43 of the lever 38 is raised and lowered as the first end 46 of the lever 38 is connected to the cam follower 41 at the attachment point 34. In this embodiment, the first end 43 of the lever is only able to be raised and lowered as the cam follower 41 follows the cam follower groove 20 because the lever 38 is connected to the frame 32 at the pivot point 37, preventing the lever from moving in other directions.

FIG. 5-9 best depict an exemplary fluid compressor according to various aspects of the present disclosure. These figures depict a fluid compressor 200 having a lever 1, a cam 2, a motor 3, a frame 4, a cylinder cap 4, a pivot point assembly 6, a cam follower bearing assembly 7, a piston assembly 8, a motor coupling bearing assembly 9, a short end leverage arm follower assembly 10, a piston guide bushing 11, and a tension spring 12. The fluid compressor 200 uses leverage to reduce power needed to compress air. The exemplary fluid compressor 200 may be able to produce a 1 to 6 leverage ratio.

In this embodiment, the cam 2 is rotated by the motor 3, and coupled to said motor 3 by a motor coupling bearing assembly 9. The motor coupling bearing assembly 9 is attached to motor shaft (not shown) that is rotated by the motor 3. In this Example, as the cam 2 rotates, it raises the lever 1 on a long throw 13 of the lever 1. In one exemplary embodiment, the long throw 13 of the lever 1 is 6 inches long and a short throw 14 of the lever 1 1 inch long, thus creating the 1 to 6 leverage ratio. This reduces power needed to compress air and results in less energy required to do the job. This reduces the high cost of compressed air because less energy is required to compress the air. In other exemplary embodiments, the long throw 13 and the short throw 14 may have different lengths, thus allowing for different leverage ratios.

As shown in FIG. 5, the use of a cam 2 as the lifting device on the long throw 13 of the lever 1. In further embodiments, there are numerous ways to actuate the lever. For example liner cam, reversing ball screw etc. In further embodiments, any of these methods of actuating the lever can be used.

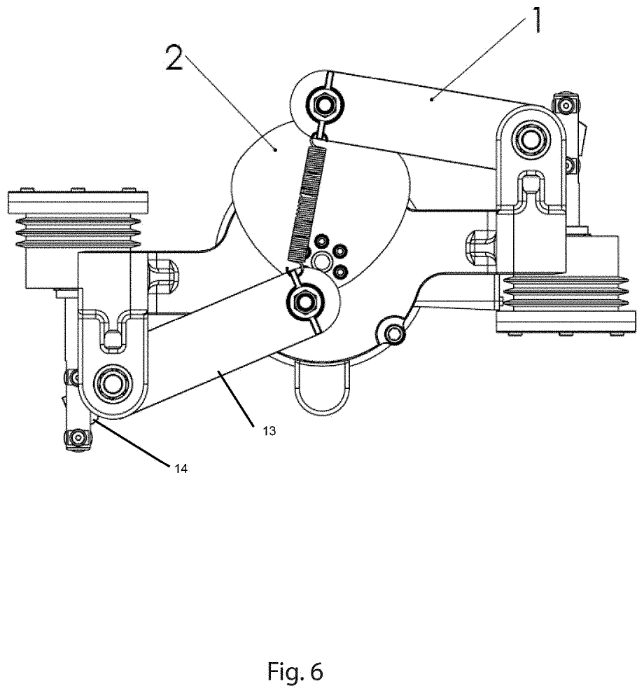

FIG. 6 is a front view of the fluid compressor shown in FIG. 5. This view shows the lever 1, the cam 2, and the long throw 13 of the lever 1, as well as the short throw 14 of the lever 1.

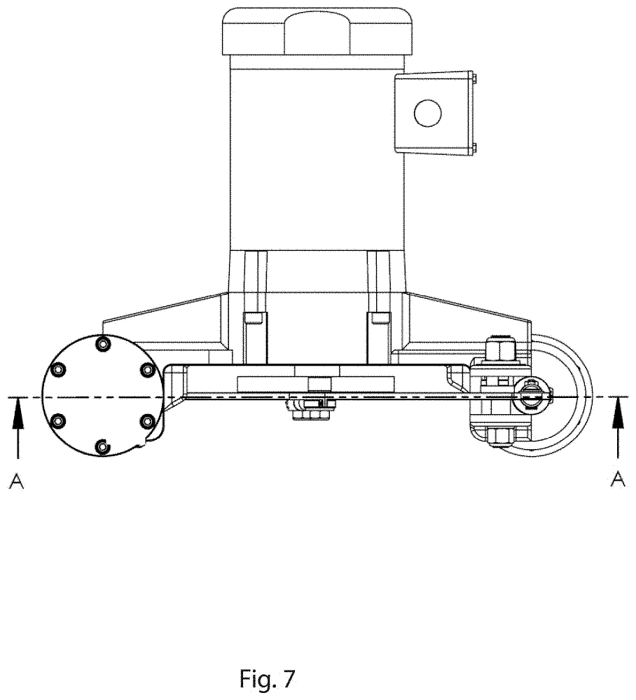

FIG. 7 is a top view of the fluid compressor shown in FIG. 5. This view best shows the motor 3 in relation to the frame 4.

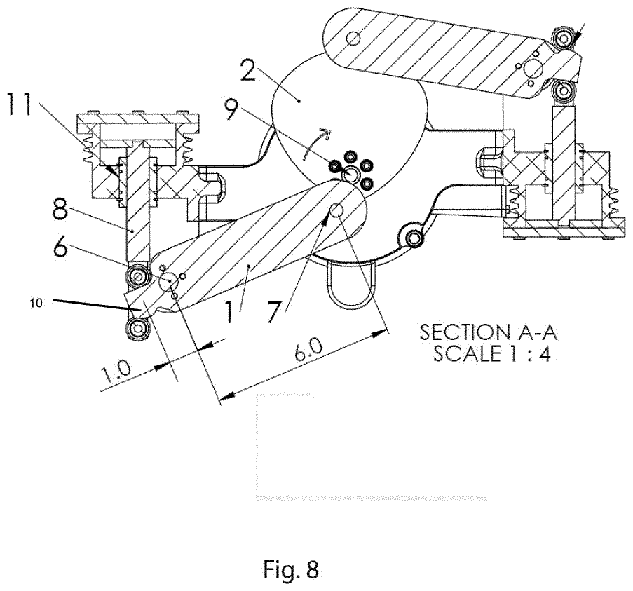

FIG. 8 is a front view of Section AA of the fluid compressor shown in FIG. 7. In this view, shown is the lever 1, the came 2, the pivot point assembly 6, the cam follower bearing assembly 7, the piston assembly 8, the motor coupling bearing assembly 9, and a short end leverage arm follower assembly 10.

As shown in FIGS. 5-9, the fluid compressor 200 may have a second lever and compressor assembly, allowing for the cam 2 to raise and lower both levers, thus compressing air in two separate compression chambers as the cam 2 is rotated. In a further embodiment, the fluid compressor 200 may include more than two levers and corresponding compressor assemblies.

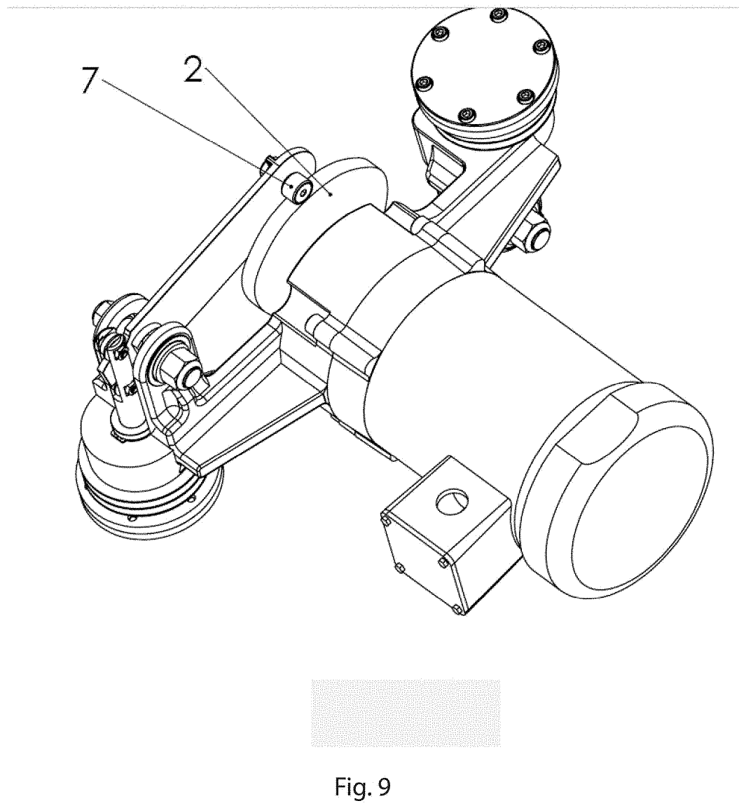

FIG. 9 is a rear perspective view of the fluid compressor 200.

Advantageously, the present description provides one or more embodiments of various types of fluid compressors. Each fluid compressor or fluid compressor system depicted herein provides advantages that overcome shortcomings of other types of fluid compressors and fluid compressor systems that are used conventionally. Further, the various embodiments shown in the Figures and described herein accommodate different sized fluid compressors and may be used in various applications, including, but not limited, to providing a lower energy fluid compressing device, system and method.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A fluid compressor, comprising:
a frame;
a piston assembly having a compression chamber connected to the frame, the compression chamber having a movable piston inside of the compression chamber and a connection rod of a smaller transverse dimension than the diameter of the piston connected to the piston at a first end of the connection rod;
a pivot point located on the frame;
a lever connected to the pivot point, the lever having a short end and a long end on opposite sides of the pivot point, the short end connected to a second end of the connection rod; and
a lifting device connected to the long end of the lever, the lifting device configured to raise and lower the long end of the lever.

2. The fluid compressor of claim 1, wherein the lifting device is a cam and a cam follower movably coupled to the cam, the cam follower connected to the long end of the lever.

3. A compressor system, comprising:
a fluid compressor, the fluid compressor comprising:
a frame,
a piston assembly having a compression chamber connected to the frame, the compression chamber having a movable piston inside of the compression chamber and a connection rod of a smaller transverse dimension than the diameter of the piston connected to the piston at a first end of the connection rod,
a pivot point located on the frame,
a lever connected to the pivot point, the lever having a short end and a long end on opposite sides of the pivot point, the short end connected to a second end of the connection rod, and
a lifting device connected to the long end of the lever; and
a motor capable of powering the lifting device, wherein the lifting device is configured to inversely raise and lower the short and long ends of the lever with respect to the pivot point, the short end of the lever moving the connection rod and piston to an up position when the short end is raised, and the fluid compressor is configured to compress a fluid when the piston is moved to the up position.

4. The fluid compressing system of claim 3, wherein the lifting device is a cam and a cam follower movably coupled to the cam, the cam follower connected to the long end of the lever.

5. The fluid compressing system of claim 4, in which the cam is connected to the motor by a motor coupling bearing assembly.

6. A method of compressing a fluid, the method comprising:
providing a fluid compressor, the fluid compressor having:
a frame,
a piston assembly having a compression chamber connected to the frame, the compression chamber having a movable piston inside of the compression chamber and a connection rod of a smaller transverse dimension than the diameter of the piston connected to the piston at a first end of the connection rod,
a pivot point located on the frame,
a lever connected to the pivot point, the lever having a short end and a long end on opposite sides of the pivot point, the short end connected to a second end of the connection rod, and
a lifting device connected to the long end of the lever, the lifting device configured to raise and lower the long end of the lever; and
using the lifting device to inversely raise and lower the short and long ends of the lever with respect to the pivot point, the short end of the lever moving the connection rod and piston to an up position when the short end is raised, and the fluid compressor is configured to compress the fluid when the piston is moved to the up position.

7. The method of claim 6, wherein the lifting device is a cam and a cam follower movably coupled to the cam, the cam follower connected to the long end of the lever.

8. The fluid compressing system of claim 7, in which the cam is connected to the motor by a motor coupling bearing assembly.
